(19) United States
(12) Patent Application Publication
(10) Pub. No.: US 2015/0207963 A1
(43) Pub. Date: Jul. 23, 2015

(54) PHOTOGRAPHIC LIGHTING SYSTEM FOR TACTILE TABLET

(71) Applicant: ACEP France, Paris (FR)

(72) Inventor: Jean-Philippe Sayag, Paris (FR)

(73) Assignee: ACEP France, Paris (FR)

(21) Appl. No.: 14/416,864

(22) PCT Filed: Jul. 25, 2013
(86) PCT No.: PCT/FR2013/051794

§ 371 Date: Mar. 12, 2015

(30) Foreign Application Priority Data
Jul. 26, 2012 (FR) 12 57243

(51) Int. Cl. H04N 5/225; G06F 3/01; G03B 15/05

(52) U.S. Cl. CPC H04N 5/2251; G03B 15/05; G06F 3/016; H04N 5/2256; G03B 2215/0582

(57) ABSTRACT

The present invention relates to a photographic lighting system for tactile tablet including a first dorsal camera noteworthy in that said system can have a removable dorsal protective shell and a light source. According to a variant, the shell and the light source are furnished with connection capabilities allowing removable fixing of the light source to said shell. Preferably, the connection means are magnets. Preferred use in connection with a measurement capture computer program for the optical centring of lenses in a spectacles frame as a function of the physiognomy of the wearer of said frames and of the characteristics of said frames.

### FIELD OF THE INVENTION

The present invention relates to a photographic lighting system for a tactile tablet.

### PRIOR ART

The term tactile tablet denotes herein an ultra-flat portable computer, in the form of a touch screen and which is particularly suitable for accessing multimedia content.

In the field of vision correction spectacles, measurements are made on the wearer fitted with spectacle frames chosen by the wearer to determine data relating to the layout configuration of the corrective lenses, particularly the optical centring thereof, opposite the wearer's eyes. These data are essentially the pupillary distance, the pupillary height, the frame inclination and curvature, the pantoscopic angle, the lens-eye distance.

To make these measurements, a series of mechanical instruments exist operated in succession by an optician trained for this purpose in order to obtain the data required. This technique requires however a certain time and requires certain know-how on the part of the practitioner so that the measurements are made correctly.

In this way, centring systems based on photographic image capture with computerised processing have been developed, making use of a measurement tool provided with points of reference and attached to the frame worn by the wearer. Such systems and measurement tools are described for example in the patents FR2896682, FR2903504 or FR2931258 held by the applicant. Using generally two captures, one as a front view and another as a side view, the set of parameters to be measured is determined.

These photographic centring systems process the corneal reflection to determine the centre of the wearer's pupils.

These centring systems are presented in column form with a screen furnished with a photographic camera, a light source or a built-in flash and a computerised processing unit.

However, progress in the technique now makes it possible to envisage using a tactile tablet furnished with a photographic camera as a capture and computerised processing unit for making these measurements enabling correct installation of the corrective lenses in a spectacle frame chosen by a wearer.

While some rare prior models were equipped therewith, none of the tablets marketed on the date of filing of the present application is equipped with a photographic flash, like most mobile telephones can be equipped with a photographic camera. There is likewise no photographic flash suitable for being added as an accessory to a tactile tablet suitable for compensating for the lack thereof as original equipment.

The person taking shots with a tactile tablet is thus dependent on the surrounding lighting and a light source, wherein the beam orientation is not precise relative to the optical axis of the tablet cameras: the quality and reliability of the measurements made are affected.

The aim of the present invention is thus that of making up for the lack of an existing solution and thus providing an easy-to-use lighting system for tactile tablets, which is particularly suitable for making more precise and reliable pupillary centring measurement than in the absence of such a lighting system.

### SUMMARY OF THE INVENTION

The present invention relates to a photographic lighting system for a tactile tablet comprising a first back camera characterised in that said system consists of a removable protective back shell furnished with a light source.

According to one alternative embodiment, the shell and the light source are furnished with connection means enabling removable fixing of the light source to said shell.

It is clear that the system thus consisting of two elements is suitable for leaving the shell permanently on a tactile tablet and adding the light source thereto as required and without limitation, enabling easier handling, transport and storage of the tablet equipped with the lighting system according to the invention.

### BRIEF DESCRIPTION OF THE FIGURES

Further advantages and features will emerge more clearly from the description hereinafter, given by way of non-limiting example, of a particularly preferred alternative embodiment of the present invention, with reference to the appended figures wherein:

FIGS. 1 and 2 are respectively a front and rear view of a tactile tablet equipped with the lighting system according to the invention of the device;

FIG. 3 is similar to FIG. 2, but without the light source;

FIG. 4 is a perspective and exploded view of the system according to the invention fitted in a tactile tablet;

FIGS. 5 and 6 are respectively a profile and front view of the light source used in FIGS. 1, 2 and 4.

### DETAILED DESCRIPTION OF THE INVENTION

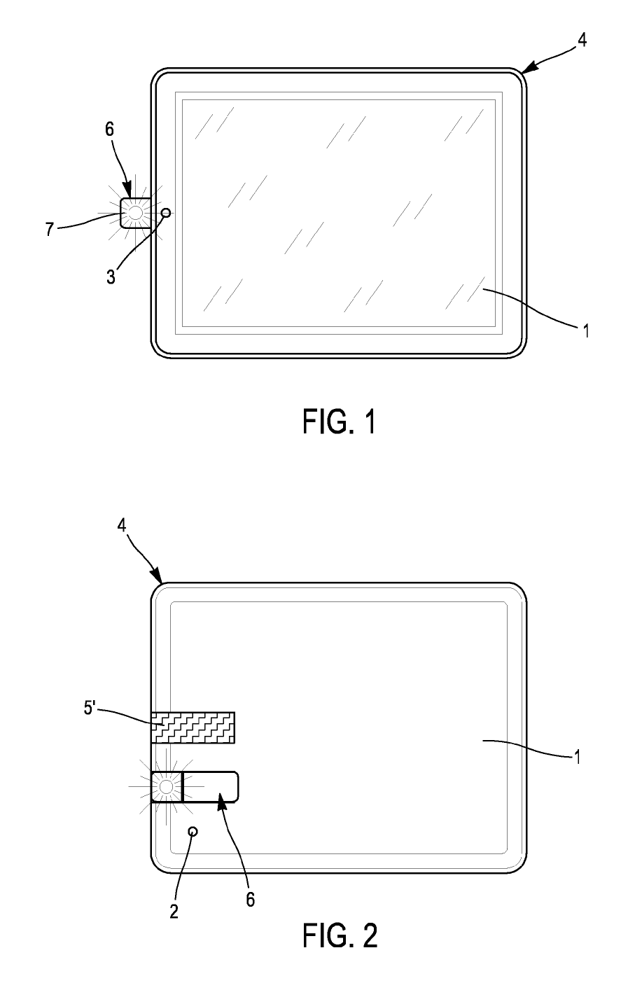

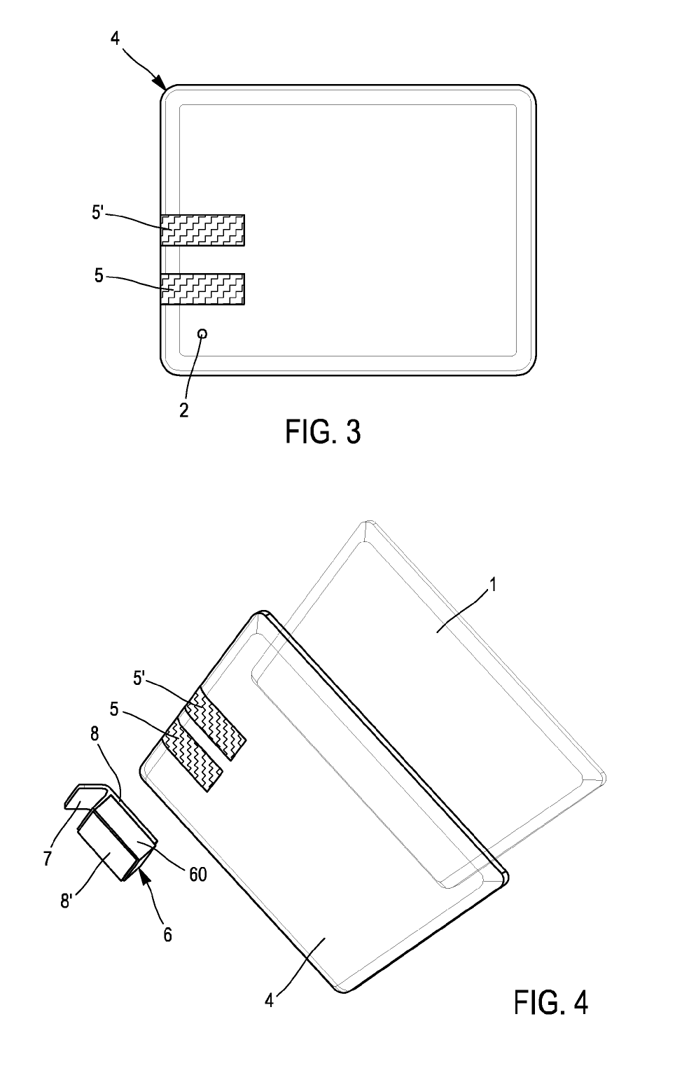

With reference to FIGS. 1 and 2, a tactile tablet 1 is shown comprising a first back camera 2 and a second front camera 3. A touch screen occupies almost all of the front face thereof. This tablet is equipped with a photographic lighting system according to the present invention.

According to one essential feature, said system consists of a removable protective back shell 4 and a light source 6.

According to the alternative embodiment shown, the shell 4 and the light source 6 are furnished with connection means enabling removable fixing of the light source 6 to said shell 4.

According to a further alternative embodiment, not shown in the figures, the light source 6 is fixed directly to the shell 4, permanently. In this embodiment, the light source 6 is advantageously a light-emitting diode, equipped with a power supply cable. Preferably, the diode is of the SMC (Surface-Mounted Component) type. Indeed, thus having very small dimensions, particularly in respect of height, it can be readily integrated in the thickness of the shell with the power supply cable thereof, so as to be flush with the surface or protrude slightly from the thickness thereof. The power supply thereof is provided by a cable connected to a communication port of the tactile tablet, for example the audio jack connector.

The shell 4 may be made of a flexible (silicone for example) or rigid (polycarbonate for example) material. It compresses recesses (not shown in the figures) corresponding to the orifices of the tactile tablet 1 on the back whereof it is intended to be positioned.

In particular, the connection means to the shell 4 form at least a first positioning area 5 of the light source 6 on said shell 4. This first, or back, positioning area 5 is suitable for positioning and fixing the light source 6 in the vicinity of the first back camera 2.

According to the alternative embodiment shown, the connection means to the shell 4 further form a second positioning area 5′ of the light source 6 to the shell 4. This second, or front, positioning area 5′ is suitable for positioning and fixing the light source 6 such that the light beam is as close as possible to the second front camera 3.

The parallel positioning as close to the optical axis of the cameras as possible of the light beam produced by the light source makes it possible to minimise parallax problems and ensures maximum measurement precision.

According to a first alternative embodiment, the connection means are of the adhesive tape type. Preferably, a repositionable type adhesive is used. When the light source 6 is not fixed to the shell 4, the adhesive tape is masked with a protective strip, so as to retain the adhesive power thereof and protect the tape from soiling.

According to a second alternative embodiment, the connection means are of the self-gripping type, using loops and hooks. In this way, for example, the positioning areas 5,5′ may consist of a strip or blocks of hooks, whereas the light source will be covered on one of the sides thereof with a least one strip or blocks of loops.

According to a final preferred alternative embodiment, the connection means are advantageously magnets.

The light source 6 will comprise at least on one face a magnetic area (for example made of metal) engaging with the magnets of the shell 4.

Advantageously, the light source 6 is furnished with magnets of opposite polarity to those of the shell 4. This advantageously makes it possible to reduce the power of the magnet on the shell and further, as explained hereinafter, also makes it possible to make a distinction in the fixing according to whether it is sought to take a photograph with the front camera or the back camera.

According to the alternative embodiment shown in FIGS. 4, 5 and 6 in particular, the light source 6 comprises a parallelepipedic main body 60 wherein the rear face is furnished with a magnet 8 for positioning on the first positioning area 5 for capture with the back camera 2 and the front face is furnished with a magnet 8′ for positioning on the second positioning area 5′ for capture with the front camera 3 and the rear face of a magnet 8 for back positioning. It is clear that it is possible to alternatively substitute the magnets 8, 8′ by metal panels engaging with the magnets of the fixing areas 5, 5′ of the shell 4.

This alternative embodiment where the connection means are magnets is particularly advantageous in terms of visual appearance, size and soiling of the positioning areas 5, 5′ as the magnets may be integrated in the thickness of the shell 4.

According to a further feature of the invention, the light source 6 comprises means for orienting the light beam generated such that it is perpendicular to the main plane of the shell 4 and thus parallel with the optical axis of the camera 2, 3 of the tactile tablet 1 when the lighting system is assembled on said tablet 1. This provides superior corneal reflection measurement precision.

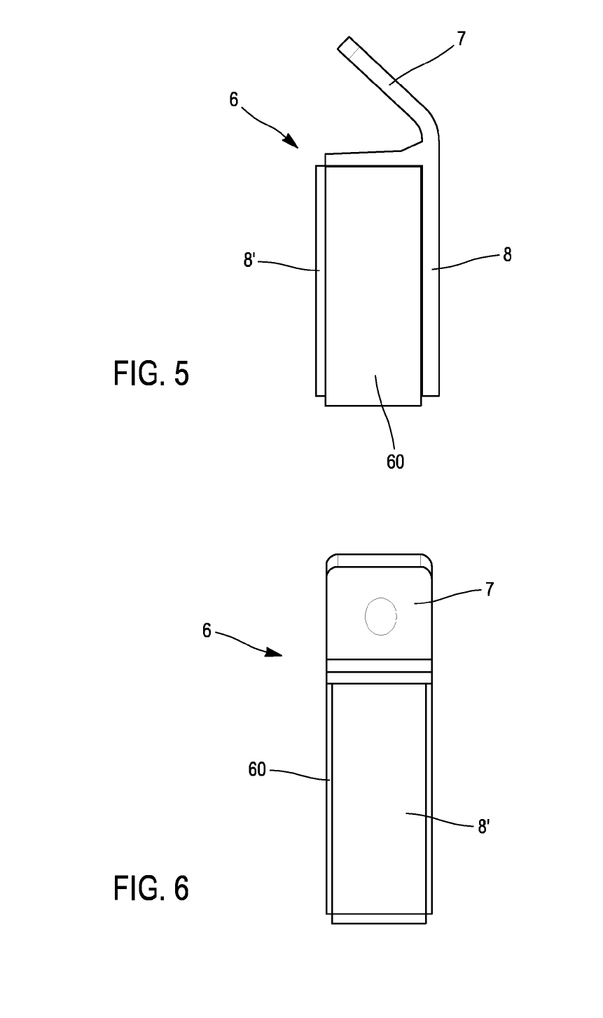

Preferably, the means for orienting the light beam comprise a reflective surface. With reference to FIGS. 5 and 6 in particular, this reflective surface may consist of a fixed plane mirror 7. According to a further alternative embodiment, not shown, the plane mirror is rotatably mounted on the head of the light source 6, so as to reflect the beam on one side or the opposite thereof according to the positioning thereof: the head of the light source is described as adjustable as it is suitable for orienting the beam in two opposite directions.

The reflective surface may also be obtained on a prism, optionally rotatably mounted.

According to a further alternative embodiment, not shown, the reflective surface is a parabolic mirror. The bulb is then positioned at the back of the parabola. Preferably, according to this alternative embodiment, the head of the light source is rotary, suitable for being rotated at least to 180°: the head is thus adjustable, according to the definition above.

If the light source 6 does not comprise an adjustable head—as is the case of the alternative embodiment shown in the figures—suitable for directing the light beam on one side or the opposite thereof by rotating this head or by switching means for orienting the beam, the light source must be positioned manually on the suitable face of the body 60 thereof such that the light beam is in the optical direction of the camera to be used for capture. It may thus advantageously be envisaged to equipped two opposite faces of the body 60 of the light source 6 with opposite fixing means and thus make a distinction between the fixing for capture with the front camera 3 or for capture with the back camera 2, the positioning areas 5, 5′ thus comprising the complementary parts of the fixing means. For example, in the case of the self-gripping strip, the first positioning area 4 will comprise hooks and the second positioning area 5′ will comprise loops. In the case of the preferred alternative embodiment with magnets, different polarities will be chosen for the two positioning areas 5, 5′ and the light source 6 will be furnished with magnets 8, 8′ of opposite polarity on the corresponding faces.

The power supply of the light source 6 may be provided either by batteries, photovoltaic cells or via a wired connection with the tactile tablet (power supply via a connection port).

The light source 6 may be equipped with any type of bulb. It will advantageously be equipped with at least one light-emitting diode, which has a very low electrical consumption and provides a very advantageous light intensity for obtaining the corneal reflection. It is also possible to envisage a light-emitting diode emitting in the infrared range. Indeed, the brightness of the pupils is amplified in the infrared range. Alternatively, the light source may be furnished with incandescent or halogen bulbs, without leaving the scope of the present invention.

According to one alternative embodiment, the switching on and off of the light source may be controlled by triggering or by preparing the photographic capture, for example via radio waves, particularly based on Bluetooth (registered trademark) technology, or via a wired connection with a communication port furnished on the tactile tablet (audio jack or Universal Serial Bus or equivalent connector).

### INDUSTRIAL APPLICATION

The photographic lighting system according to the invention is particularly intended to be fitted on tactile tablets furnished with a computer program suitable for making measurements of spectacle frames worn by a subject in order to customise the corrective lens and ensure the centring thereof according to the wearer's physiognomy.

Furthermore, in the cases wherein the light source emits in the infrared range, the system may be used to convert the tactile tablet into a home automation remote control.

1-12. (canceled)

13. Photographic lighting system for a tactile tablet comprising:
a first back camera and a removable protective back shell furnished with a light source.

14. System according to claim 13, wherein the light source is rigidly connected permanently to said shell.

15. System according to claim 13, wherein the shell and the light source are furnished with a connection enabling removable fixing of the light source to said shell.

16. System according to claim 15, wherein the connection means to the shell forms at least a first positioning area of the light source on said shell.

17. System according to claim 16, wherein the connection to the shell further forms a second positioning area of the light source to the shell.

18. System according to claim 15, wherein the connection comprises adhesive tape type.

19. System according to claim 15, wherein the connection comprises a self-gripping type using loops and hooks.

20. System according to claim 15, wherein the connection comprises magnets.

21. System according to claim 20, wherein the light source is furnished with magnets of opposite polarity to those of the shell.

22. System according to claim 15, wherein the light source comprises means for orienting the light beam generated such that it is perpendicular to the main plane of the shell and thus parallel with the optical axis of the camera of the tactile tablet when the lighting system is assembled on said tablet.

23. System according to claim 22, wherein the orientation means comprise a reflective surface.

24. System according to claim 22, wherein the light source comprises an adjustable head.

25. System according to claim 22, wherein the power supply of the light source is provided by a cable connected to the audio jack connector.
